(19) United States
(12) Patent Application Publication
(10) Pub. No.: US 2026/0350667 A1
(43) Pub. Date: Nov. 5, 2026

(54) Voice-Activated Input to Sealed Execution System With Tool-Origin Verification

(71) Applicant: ADRIAN FARIAS JARAMILLO, JURUPA VALLEY, CA (US)

(72) Inventor: ADRIAN FARIAS JARAMILLO, JURUPA VALLEY, CA (US)

(21) Appl. No.: 19/335,822

(22) Filed: Sep. 22, 2025

Related U.S. Application Data
(63) Continuation of application No. 19/197,894, filed on May 2, 2025.
(60) Provisional application No. 63/786,937, filed on Apr. 10, 2025.
(60) Provisional application No. 63/787,944, filed on Apr. 13, 2025.
(60) Provisional application No. 63/788,834, filed on Apr. 15, 2025.

(51) Int. Cl. G06Q 30/0601; G06Q 10/083

(52) U.S. Cl. CPC G06Q 30/0611; G06Q 10/083

(57) ABSTRACT

A voice-activated execution system for commercial platforms that verifies tool origin before initiating fulfillment. Voice input is parsed, scored, and matched to approved tool interfaces. Unverified inputs are blocked. The system integrates escrow, jurisdictional, and metadata controls to ensure sealed execution from voice to fulfillment.

### CROSS-REFERENCE TO RELATED APPLICATIONS

This application is a continuation of U.S. Utility patent application Ser. No. 19/197,894, filed May 2, 2025, which claims the benefit of the following U.S. Provisional Patent Applications, each of which is incorporated herein by reference in its entirety:
U.S. Provisional Application No. 63/786,937, filed Apr. 10, 2025, titled “System and Method for Buyer-Initiated Marketplace Transactions Across Multiple Industries”
U.S. Provisional Application No. 63/787,944, filed Apr. 13, 2025, titled “Sealed Toolset and Logic Framework for Buyer-Initiated Offer Systems”
U.S. Provisional Application No. 63/788,834, filed Apr. 15, 2025, titled “Toolset Protection for Modular Buyer-Initiated Offer Ecosystem”
U.S. Provisional Application No. 63/791,534, filed Apr. 20, 2025, titled “Modular Toolset Architecture for Multi-Sector Buyer-Initiated Commerce Infrastructure”
U.S. Provisional Application No. 63/792,918, filed Apr. 23, 2025, titled “Lockdown: Final Enforcement Tools for Global Buyer-Initiated Transaction Control”

### FIELD OF THE INVENTION

The present invention relates generally to voice-activated commercial execution systems and, more specifically, to voice-triggered input mechanisms that initiate buyer-verified transactions through sealed rails and trusted platform interfaces.

### BACKGROUND OF THE INVENTION

Conventional voice assistants can perform general search or command tasks, but they lack the ability to securely trigger binding commercial transactions within a controlled platform ecosystem.

Current systems also fail to verify whether the voice input originates from a platform-authorized interface, allowing open systems to misroute or exploit buyer voice commands.

There is a need for a platform-native voice execution mechanism that ensures tool-origin verification and full compliance with licensed fulfillment logic.

### SUMMARY OF THE INVENTION

This invention enables sealed execution via voice input, tightly bound to trusted platform-origin tools and escrow-verified fulfillment paths.

Voice input is only accepted when originating from licensed interfaces, such as official apps, hardware modules, or embedded API-controlled tools.

The system converts voice input into a structured commercial request, activates tool-specific logic, and locks all downstream fulfillment to sealed execution rails.

Voice-triggered transactions are denied if tool origin cannot be verified.

### DETAILED DESCRIPTION OF THE INVENTION

The system comprises a voice input module that is native to the platform or embedded via approved APIs.

Voice input is monitored for metadata, including device signature, app origin, and session token.

Upon receipt, the input is parsed into a structured fulfillment query linked to user account and platform tool.

The system verifies origin by cross-referencing device/app signature against a registry of licensed interfaces.

Only requests from approved origins proceed to the tool-chain execution stack.

Fulfillment logic includes escrow gating, jurisdictional filtering, trust-tier enforcement, and vendor lock-in.

Transactions triggered by voice input are recorded with full metadata and timestamp for audit and compliance.

The system denies execution if origin metadata is missing, altered, or unlicensed.

Voice logic modules can be embedded in physical devices, vehicles, kiosks, or software agents, provided they are platform-bound.

Fulfillment requests issued by autonomous systems or agents are held to the same verification standard as human voice triggers.

The invention prevents unauthorized platforms from capturing, rerouting, or fulfilling voice input outside the licensed rail system.

What is claimed is:

1. A system comprising:
a voice input module embedded within a licensed platform interface;
a tool-origin verification engine;
and a sealed execution controller that triggers fulfillment only upon validated input origin.

2. The system of claim 1, wherein the tool-origin verification engine cross-references a registry of licensed devices, apps, or interface signatures.

3. The system of claim 1, wherein the sealed execution controller denies fulfillment if metadata fails verification.

4. A method comprising:
receiving a voice input;
determining its origin;
parsing the input into a structured commercial trigger;
and executing fulfillment only through a sealed platform rail.

5. The system of claim 1, wherein voice input is captured from mobile apps, IoT hardware, or software tools approved by the platform.

6. The method of claim 4, wherein origin metadata includes device ID, platform session, user token, and location signature.

7. The system of claim 1, further comprising a compliance logger that stores metadata and decision logs for audit purposes.

8. A system wherein unlicensed third-party voice tools are prevented from initiating fulfillment.

9. The system of claim 1, wherein escrow logic is triggered only upon tool-verified voice activation.

10. The system of claim 1, wherein voice-triggered commands must align with predefined tool permissions before execution.

11. A voice input-to-fulfillment method comprising:
verifying the voice origin;
activating escrow and vendor lock filters; and delivering fulfillment through a trust-gated execution path.

12. The method of claim 11, wherein fulfillment is routed through jurisdictional filters before authorization.

13. The system of claim 1, wherein unauthorized voice input is logged and flagged for enforcement.

14. A method comprising:
embedding voice modules into physical devices;
tethering device identity to platform license;
and allowing commercial execution only upon full verification.

15. The system of claim 1, wherein voice input can originate from autonomous systems provided they are tethered to platform-licensed identity modules.

16. The system of claim 1, wherein voice-triggered offers are held in escrow until license and trust verification is complete.

17. A sealed execution rail triggered by voice input and locked by metadata, license, and platform-origin scoring.

18. The method of claim 4, wherein any offer attempt bypassing voice-origin verification is denied and recorded.

19. A compliance framework wherein voice-triggered execution is recorded, monitored, and enforced under platform governance.

20. A platform-bound execution control system comprising:
voice input capture, origin validation, trust enforcement, escrow lock, and structured fulfillment routing.

21. The system of claim 1, wherein actor credentials must be verified via a third-party identity vault prior to execution clearance.
